(19) United States
(12) Patent Application Publication
(10) Pub. No.: US 2009/0004898 A1
(43) Pub. Date: Jan. 1, 2009

(54) WIRELESS NETWORK CARD AND USB INTERFACE PROTECTION STRUCTURE THEREOF

(75) Inventor: Gary HSU, Linkou Township (TW)

Correspondence Address: SUGHRUE MION, PLLC, 2100 PENNSYLVANIA AVENUE, N.W., SUITE 800, WASHINGTON, DC, 20037, US

(73) Assignee: BANDRICH INC., SINDIAN CITY (TW)

(21) Appl. No.: 12/036,661

(22) Filed: Feb. 25, 2008

(30) Foreign Application Priority Data
Jun. 15, 2007 (TW) 096209960

(51) Int. Cl. H01R 13/44

(52) U.S. Cl. 439/135

(57) ABSTRACT

A universal serial bus (USB) interface protection structure for protecting a universal serial bus interface wrapped with a metal layer protruding from an electronic device. The USB interface protection structure includes a detachable cap having an open end and a close end, a cavity located on the close end, a magnet contained in the cavity, and a cap cover covering the detachable cap. The magnet has a magnetic force to attract the metal layer of the USB interface for retaining the USB interface in the detachable cap when the USB interface inserts into the detachable cap through the open end. A wireless network card utilizing the USB interface protection structure is also disclosed.

### RELATED APPLICATIONS

This application claims priority to Taiwan Application Serial Number 96209960, filed Jun. 15, 2007, which is herein incorporated by reference.

### BACKGROUND

1. Field of Invention

The present invention relates to a USB interface protection structure. More particularly, the present invention relates to a USB interface protection structure with a magnet.

2. Description of Related Art

The development of the Internet and the popularization of personal computers enable data from different places to be communicated. However, most of the current Internet infrastructure is connected with wires made of different materials, such as optical fibers. Thus, using wireless network card eliminates the aforementioned problems, and creates a convenient communications environment.

The wireless network card has an interface to connect to the computer. The interface may be a universal serial bus (USB) interface. The USB interface is usually capped with a detachable cap to protect the USB interface. However, the detachable cap may easily be lost, disappear or become loosened with the USB interface after a period of time. Thus, the USB interface is lack of protection. The collision between the USB and the surrounding environment would reduce the life of the USB interface.

For the foregoing reasons, there is a need for protecting the USB interface efficiently.

### SUMMARY

The invention provides a universal serial bus (USB) interface protection structure for protecting a universal serial bus interface wrapped with a metal layer protruding from an electronic device. The USB interface protection structure includes a detachable cap having an open end and a close end, a cavity located on the close end, a magnet contained in the cavity, and a cap cover covering the detachable cap. The magnet has a magnetic force to attract the metal layer of the USB interface for retaining the USB interface in the detachable cap when the USB interface inserts into the detachable cap through the open end.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an explosion diagram of an embodiment of the USB interface protection structure of the invention; and

FIG. 2 is an oblique diagram of an embodiment of a wireless network card utilizing the USB interface protection structure of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The conventional universal serial bus (USB) interface protrudes from a main body of an electronic device. A conventional protection structure for the USB interface is a detachable cap to pressing match with the USB interface. However, the detachable cap would no longer couple to the USB interface firmly with the increasing utility time. Thus, the detachable cap would become loose and easily separate from the USB interface.

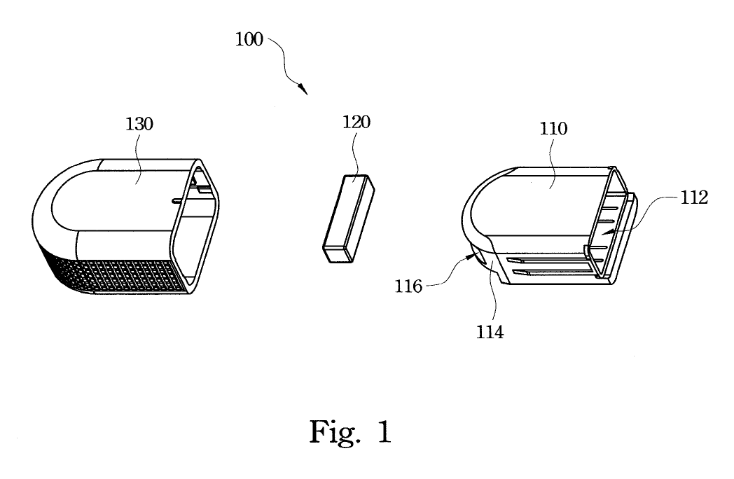

Refer to FIG. 1. FIG. 1 illustrates an explosion diagram of an embodiment of the USB interface protection structure of the invention. The USB interface protection structure 100 includes a detachable cap 110, a magnet 120, and a cap cover 130. The detachable cap 110 has an open end 112 and a closed end 114. The USB interface protection structure 100 further includes a cavity 116 located at the close end 114 of the detachable cap 110. The magnet 120 is contained in the cavity 116. The cap cover 130 may cover the detachable cap 130, and the cap cover 130 may further be ultrasonic welded or glued on the detachable cap 110. The cavity 116 may be located opposite to the open end 112, and the magnet 120 may be contained between the close end 114 and the cap cover 130.

The USB interface (not shown) may insert into the detachable cap 110 through the open end 112. The magnet 120 may have a magnetic force to attract the USB interface to retain the USB interface in the detachable cap 110.

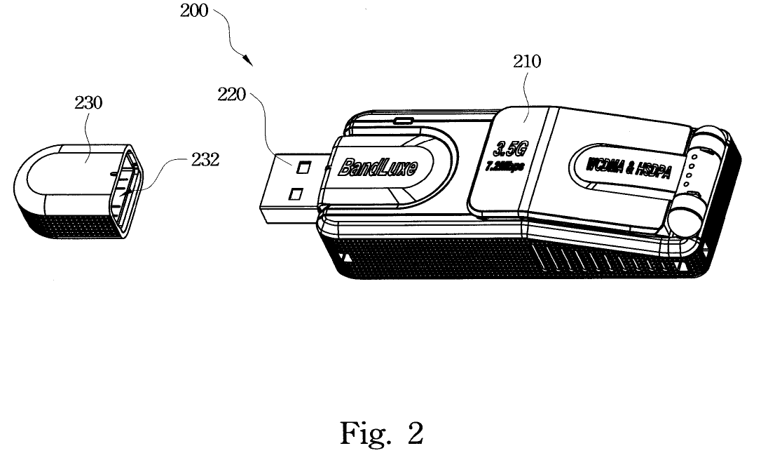

Refer to FIG. 2. FIG. 2 illustrates an oblique diagram of an embodiment of a wireless network card utilizing the USB interface protection structure of the invention. The wireless network card 200 includes a main body 210, a universal serial bus (USB) interface 220 protruding from the main body 210, and the USB interface protection structure 230. The USB interface 220 is wrapped with a metal layer, such as an iron layer. The magnet (not shown) in the USB protection structure 230 may have a magnetic force to attract the metal layer of the USB interface 220 and retain the USB interface 220 in the USB interface protection structure 230.

The USB interface protection structure may be utilized in other electronic devices with the USB interface, such as a USB disk, a digital television card, a mp3 player, etc. The USB interface protection structure may cap on the USB interface firmly with the magnetic attraction between the magnet of the USB interface protection structure and the metal layer of the USB interface. The USB interface protection structure would not easily separate with the USB interface caused by the detachable cap loosening with the USB interface with the increasing utility time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A universal serial bus (USB) interface protection structure for protecting a universal serial bus interface wrapped with a metal layer protruding from an electronic device, the USB interface protection structure comprising:
a detachable cap having an open end and a close end;
a cavity located on the close end;
a magnet contained in the cavity; and
a cap cover covering the detachable cap, wherein the magnet has a magnetic force to attract the metal layer of the USB interface for retaining the USB interface in the detachable cap when the USB interface is inserted into the detachable cap through the open end.

2. The USB interface protection structure of claim 1, wherein the electronic device is a wireless network card.

3. The USB interface protection structure of claim 1, wherein a material of the metal layer is an iron.

4. The USB interface protection structure of claim 1, wherein the cavity is located opposite to the open end, and the magnet is contained between the close end and the cap cover.

5. A wireless network card comprising:
a main body;
a universal serial bus (USB) interface wrapped with a metal layer protruded from the main body; and
a USB interface protection structure capped on the USB interface, the USB interface protection structure comprising:
a detachable cap having an open end and a close end,
a cavity located on the close end,
a magnet contained in the cavity, and
a cap cover covering the detachable cap, wherein the magnet has a magnetic force to attract the metal layer of the USB interface for retaining the USB interface in the detachable cap when the USB interface is inserted into the detachable cap through the open end.

6. The wireless network card of claim 5, wherein a material of the metal layer is an iron.

7. The wireless network card of claim 5, wherein the cavity is opposite to the open end, and the magnet is contained between the close end and the cap cover.
